(19) United States
(12) Patent Application Publication
(10) Pub. No.: US 2012/0251218 A1
(43) Pub. Date: Oct. 4, 2012

(54) Writing Utensil

(76) Inventor: Leonard Gratch, Lee Center, NY (US)

(21) Appl. No.: 13/439,182

(22) Filed: Apr. 4, 2012

Related U.S. Application Data
(60) Provisional application No. 61/471,354, filed on Apr. 4, 2011.

(51) Int. Cl. B43K 19/00

(52) U.S. Cl. 401/6

(57) ABSTRACT

A writing utensil for helping a user learn to properly hold the utensil. The writing utensil includes three notches that properly align the first finger, middle finger, and thumb of the user. The notches can be color-coded to further encourage proper placement of the utensil in the user's hand.

The present application claims priority to U.S. Provisional Patent Application Ser. No. 61/471,354, filed Apr. 4, 2011, the entirety of which is hereby incorporated by reference.

### BACKGROUND OF THE INVENTION

1. FIELD OF THE INVENTION

The present invention relates to a writing utensil and, more specifically, to a writing utensil for helping a user learn to write.

2. DESCRIPTION OF THE RELATED ART

Writing utensils such as pencils, pens, markers, and crayons are everyday items throughout most of the world. Learning to use these utensils are an essential part of early education, with many hours of kindergarten-level education spent learning how to properly write letters and numbers. Often, learning how to hold these utensils can be one of the most difficult steps in the process. Learning how to properly hold a writing utensil can be even more challenging for students or children with learning disabilities or physical disabilities. As a result, there is a demand for improved methods of teaching students or children how to properly hold or use writing utensils.

### BRIEF SUMMARY OF THE INVENTION

It is therefore a principal object and advantage of the present invention to provide a writing utensil that helps the user properly hold the utensil.

Other objects and advantages of the present invention will in part be obvious, and in part appear hereinafter.

In accordance with the foregoing objects and advantages, the present invention provides a writing utensil comprising: (i) a first notch which receives the end of a user's first finger; (ii) a second notch which receives the end of the user's thumb; and (iii) a third notch which receives a portion of the user's middle finger, wherein the first, second, and third notches are positioned such that when the user properly engages the notches, the user is properly holding the utensil. In further embodiments, one or more of the notches are color-coded to further encourage proper placement of the utensil in the user's hand.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIGS. 1-5 are photographs of the writing utensil according to one embodiment of the present invention.

### DETAILED DESCRIPTION OF THE INVENTION

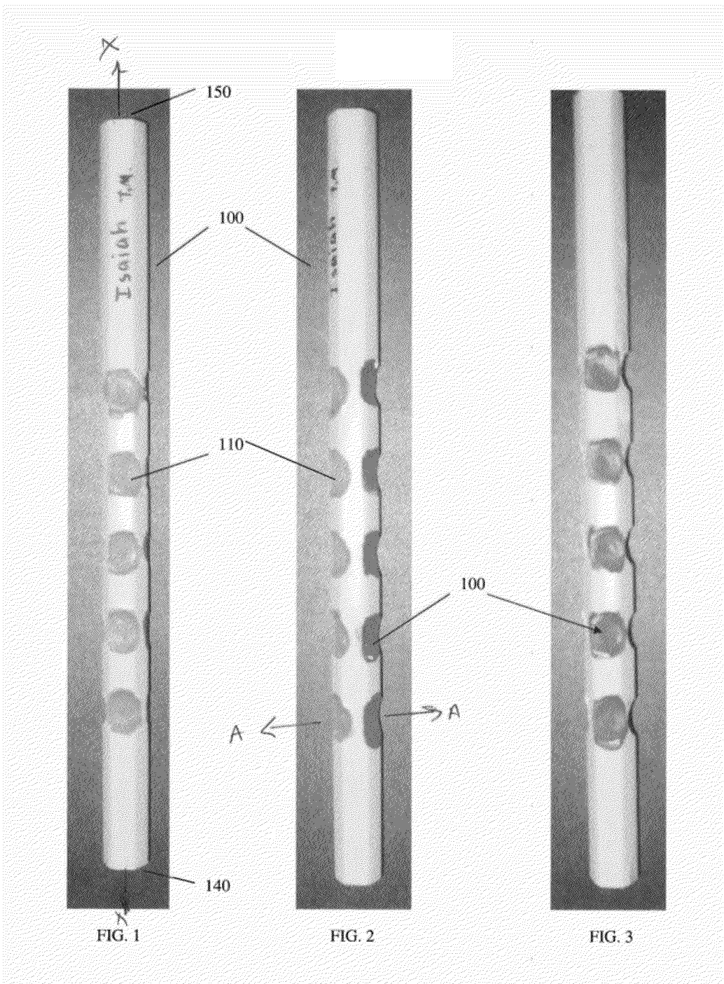

Referring now to the drawings, wherein like reference numerals refer to like parts throughout, there is seen in FIG. 1 a writing utensil 100 according to one embodiment of the present invention. The writing utensil can be any utensil that must be held during use, including pencils, pens, highlighters, crayons, markers, etc. In a preferred embodiment, writing utensil 100 comprises approximately six sides, although any number of sides are possible. A crayon, for example, does not have “sides,” but rather has a single, smooth, rounded exterior.

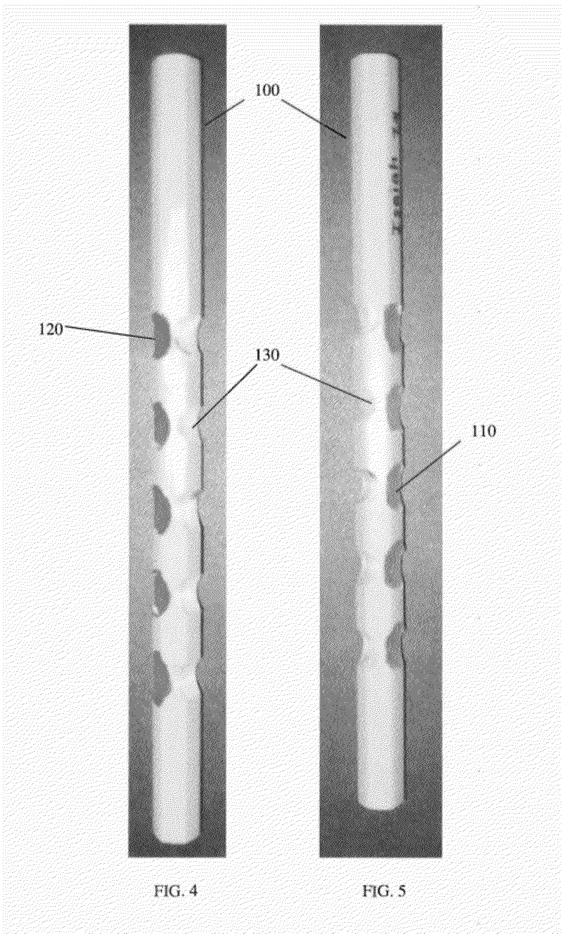

Device 100 preferably has a set of three “notches”—notch 110, notch 120, and notch 130 —formed in the device and located around its exterior, as shown in FIGS. 1-5. There are a series of these set of notches located along the device anywhere from the bottom 140 of the device to the top 150 of the device. In FIGS. 1-5 for example, writing utensil 100 has a series of three sets of five notches each extending from the bottom to the top of the device in spaced relation to one another along respective axes, each parallel to the other as well as to the utensil's longitudinal axis X-X. Thus, as the writing utensil is used and is progressively shortened, in the case of a pencil for example, the user has a set of new notches to use. Each corresponding notch in each set lies in a plane A-A that is transverse to axis X-X. If the writing utensil itself is not degraded as it is used, in the case of a pen or highlighter, for example, only one set of notches may be necessary.

The notches are designed to comfortably fit a wide range of hand and/or finger sizes, and are designed to guide the user's hand and the utensil into proper alignment for writing or other use. For example, notch 110 is preferably used for the first finger. The tip of the user's first finger fits comfortably into notch 110 regardless of the size of the finger. Notch 120 is preferably used for a portion of the thumb. Lastly, notch 130 receives a portion of the user's middle finger. In a preferred use, the portion of the user's middle finger received by notch 130 is the portion located on the side of the distal phalanges, next to the fingernail. For a right-handed user, the left side of the middle finger's distal phalanges will fit into notch 130, while for a left-handed user the right side of the middle finger's distal phalanges will fit into notch 130.

As suggested above, the use of the notches will vary depending on whether the user is right- or left-handed. The description provided above is for a right-handed user. If the user is left-handed, notch 110 receives a portion of the thumb, notch 120 receives a portion of the first finger, and notch 130 receives a portion of the middle finger.

Further, the descriptions provided above are for using writing utensil 100 to write. If the user is using the utensil to erase, the device is held upside-down, and notches 110 and 120 are reversed. The middle finger, however, usually fits into notch 130 regardless of right- or left-handedness, or whether the device is upside-down.

In a preferred embodiment, the notches are color-coded, numbered, properly shaped, or otherwise coded for proper orientation of the fingers and the notches. For example, in FIGS. 1-5, notches 110 and 120 are roughly round to properly receive a portion of the ends of the first finger and thumb. Notch 130, however, is slightly elongated to properly receive a portion of the side of the middle finger. That is, the tip of the user's middle finger—which would result in an incorrect usage of the writing utensil—does not comfortably fit into notch 130 because it is elongated rather than round.

Also in FIGS. 1-5, notches 110 and 120 are color-coded. Notch 110 is green, while notch 120 is red, although any combination of colors can be used. Alternatively, the notches could be labeled “1” “2” and “3,” or can be labeled with “first” “thumb” and “middle,” for example. Any system of notation that adequately informs the user of the proper orientation can be used.

Although the present invention has been described in connection with a preferred embodiment, it should be understood that modifications, alterations, and additions can be made to the invention without departing from the scope of the invention as defined by the claims.

What is claimed is:

1) A writing utensil, comprising:
a) an elongated body member extending along a longitudinal axis and having a writing end;
a first notch of predetermined shaped formed in said body member at a first intermediate position along the length thereof;
b) a second notch formed in said body member at a second intermediate position along the length thereof;
c) a third notch formed in said body member at a third intermediate position along the length thereof;
d) wherein said first, second, and third intermediate positions each extend in a common plane that is transverse to said longitudinal axis.

2) The writing utensil of claim 1, wherein said first, second, and third notches comprise first, second and third visual indicators, respectively.

3) The writing utensil of claim 1, wherein said first, second and third intermediate positions are positioned adjacent said writing end.

4) The writing utensil of claim 1, wherein said first and second notches are of a first predetermined shape, and said third notch is of a second predetermined shape different from said first predetermined shape.

5) A writing utensil, comprising:
a) an elongated body member extending along a longitudinal axis and having a writing end;
b) a first plurality of notches formed in said body member and extending in spaced relation to one another along a first axis that is parallel to said longitudinal axis;
c) a second plurality of notches formed in said body member and extending in spaced relation to one another along a second axis that is parallel to said longitudinal axis; and
d) a third plurality of notches formed in said body member and extending in spaced relation to one another along a third axis that is parallel to said longitudinal axis;
e) wherein corresponding ones of said first, second, and third plurality of notches extend in common planes with each other with each common plane extending transverse to said longitudinal axis.

6) The writing utensil of claim 5, wherein said first, second, and third plurality of notches comprise first, second and third visual indicators, respectively.

7) The writing utensil of claim 5, wherein each of said first and second plurality of notches are of a first predetermined shape, and each of said third plurality of notches are of a second predetermined shape different from said first predetermined shape.
